(19) United States
(12) Patent Application Publication
(10) Pub. No.: US 2019/0078238 A1
(43) Pub. Date: Mar. 14, 2019

(54) Composite Thread Cable for Aquaculture Cage

(71) Applicant: Yuang Hsian Metal Industrial Corp., Changua City (TW)

(72) Inventor: Kuo-Ta Chang, Changua City (TW)

(21) Appl. No.: 15/704,178

(22) Filed: Sep. 14, 2017

(51) Int. Cl. D02G 3/04; A01K 61/00; B21C 1/02

(52) U.S. Cl. CPC D02G 3/04; B21C 1/02; A01K 61/00

(57) ABSTRACT

A composite thread cable for an aquaculture cage includes multiple multi-filament polyester fiber yarn wires and at least one or more than one copper alloy wire blending and interweaving with the multi-filament polyester fiber yarn wires. Each of the multi-filament polyester fiber yarn wires is made of flexible material. The at least one or more than one copper alloy wire is made of hard material. The at least one or more than one copper alloy wire is intertwined in the multi-filament polyester fiber yarn wires tightly and closely to construct the composite thread cable.

### BACKGROUND OF THE INVENTION

### 1. Field of the Invention

The present invention relates to a composite thread cable and, more particularly, to a composite thread cable for an aquaculture cage.

### 2. Description of the Related Art

A first conventional aquaculture cage 10 in accordance with the prior art shown in FIG. 6 comprises multiple plastic cables 11. Each of the plastic cables 11 is formed by multifilament nylon yarns weaving with each other. The plastic cables 11 are flexible and stretchable. However, the plastic cables 11 have a poor strength, so that the plastic cables 11 are easily damaged by aggressive predators, thereby causing fish losses. In addition, each of the plastic cables 11 is formed by multifilament nylon yarns weaving with each other, so that the plastic cables 11 have strong water absorption, and the marine life “A” (such as barnacles or seaweeds) are easily attached to and grown on the plastic cables 11, thereby causing inconvenience and difficulty of cleaning the aquaculture cage 10, increasing the rearing cost, decreasing stability of the aquaculture cage 10, and shortening the lifetime of the aquaculture cage 10.

A second conventional aquaculture cage 10a in accordance with the prior art shown in FIG. 7 comprises multiple copper cables 11a. The copper cables 11a have a great strength to prevent intrusion of aggressive predators. The copper cables 11a are oxidized to produce oxides “B” to provide an antibacterial effect. However, the copper cables 11a of the aquaculture cage 10a have a complicated assembly process, are operated difficulty, and have a high cost of assembly.

### BRIEF SUMMARY OF THE INVENTION

In accordance with the present invention, there is provided a composite thread cable for an aquaculture cage, comprising multiple multi-filament polyester fiber yarn wires and at least one or more than one copper alloy wire blending and interweaving with the multi-filament polyester fiber yarn wires. Each of the multi-filament polyester fiber yarn wires is made of flexible material. The at least one or more than one copper alloy wire is made of hard material. The at least one or more than one copper alloy wire is intertwined in the multi-filament polyester fiber yarn wires tightly and closely to construct the composite thread cable.

In accordance with the present invention, there is provided a method comprising:

a first step (a) including providing a determined amount of copper alloy staple in a melting furnace, adding a determined amount of metallic element in the melting furnace, and melting and kneading the copper alloy staple and the metallic element at a high temperature to form a copper alloy melting liquid, wherein the copper alloy staple contains an electrolytic copper with a high purity, and the metallic element has a high tensile strength, is erosion resistant and is wear resistant;

a second step (b) including filling the copper alloy melting liquid into a casting furnace to directly form a copper alloy embryo material by a casting process;

a third step (c) including stretching the copper alloy embryo material by a tensile process to form a copper alloy wire with a determined diameter;

a fourth step (d) including blending and interweaving at least one or more than one copper alloy wire with multiple multi-filament polyester fiber yarn wires by a determined proportion; and

a fifth step (e) including intertwining the at least one or more than one copper alloy wire in the multi-filament polyester fiber yarn wires tightly and closely to construct a composite thread cable which contains the at least one or more than one copper alloy wire and the multi-filament polyester fiber yarn wires.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a flow chart of a method for molding a composite thread cable for an aquaculture cage in accordance with the preferred embodiment of the present invention.

FIG. 2 is a schematic operational view showing a casting process for forming a copper alloy embryo material in accordance with the preferred embodiment of the present invention.

FIG. 3 is a partially perspective view of an aquaculture cage and a composite thread cable in accordance with the preferred embodiment of the present invention.

FIG. 4 is a perspective view of the composite thread cable in accordance with the preferred embodiment of the present invention.

FIG. 5 is a cross-sectional view of the composite thread cable in accordance with the preferred embodiment of the present invention.

FIG. 6 is a partially perspective view of a first conventional aquaculture cage in accordance with the prior art.

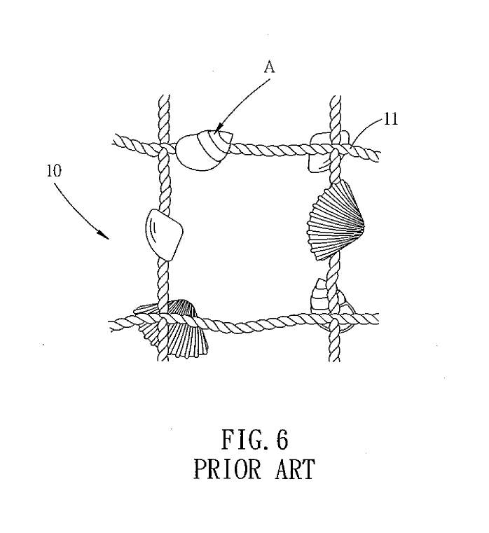

FIG. 7 is a partially perspective view of a second conventional aquaculture cage in accordance with the prior art.

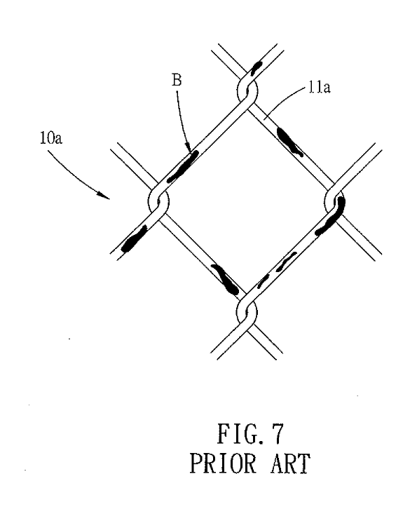

### DETAILED DESCRIPTION OF THE INVENTION

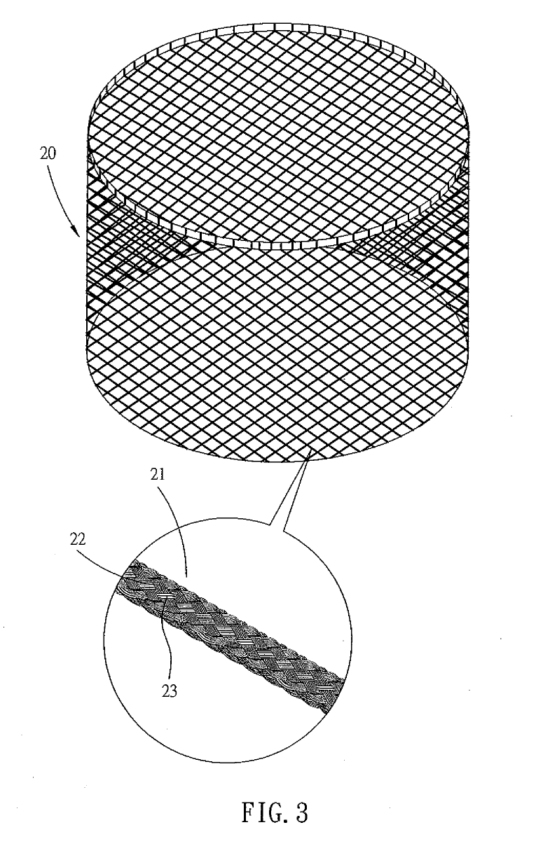

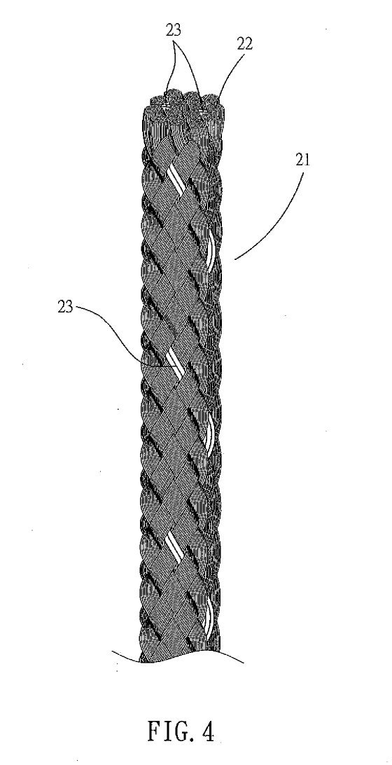

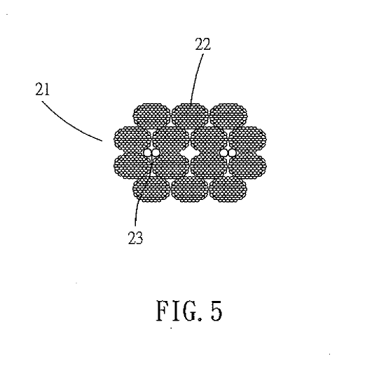

Referring to FIGS. 3-5, a composite thread cable 21 for an aquaculture cage 20 in accordance with the preferred embodiment of the present invention comprises multiple multi-filament polyester fiber yarn wires 22 and at least one or more than one copper alloy wire 23 blending and interweaving with the multi-filament polyester fiber yarn wires 22. Each of the multi-filament polyester fiber yarn wires 22 is made of flexible material. The at least one or more than one copper alloy wire 23 is made of hard material. The at least one or more than one copper alloy wire 23 is intertwined in the multi-filament polyester fiber yarn wires 22 tightly and closely to construct the composite thread cable 21.

In the preferred embodiment of the present invention, each of the multi-filament polyester fiber yarn wires 22 is made of plastic material.

In the preferred embodiment of the present invention, the multi-filament polyester fiber yarn wires 22 have a number more than that of the at least one or more than one copper alloy wire 23.

In the preferred embodiment of the present invention, each of the multi-filament polyester fiber yarn wires 22 is made of Mono nylon, Multi-Mono nylon, Polyethylene, Nylon, Knotless, tetoron or Dyneema.

In the preferred embodiment of the present invention, the at least one or more than one copper alloy wire 23 is encompassed by the multi-filament polyester fiber yarn wires 22.

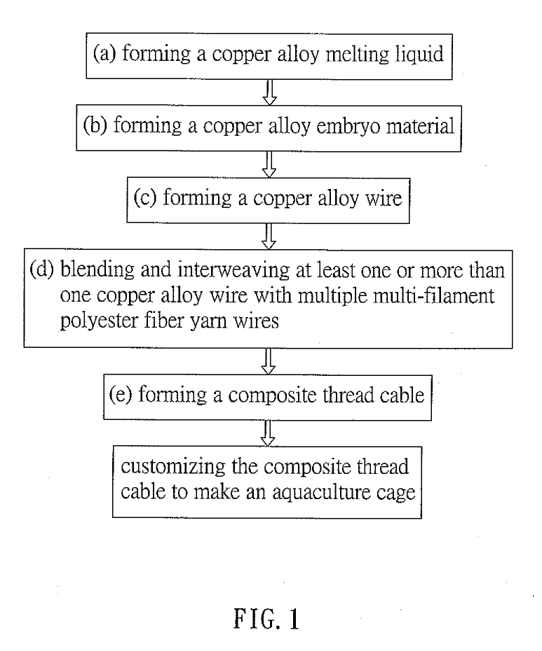

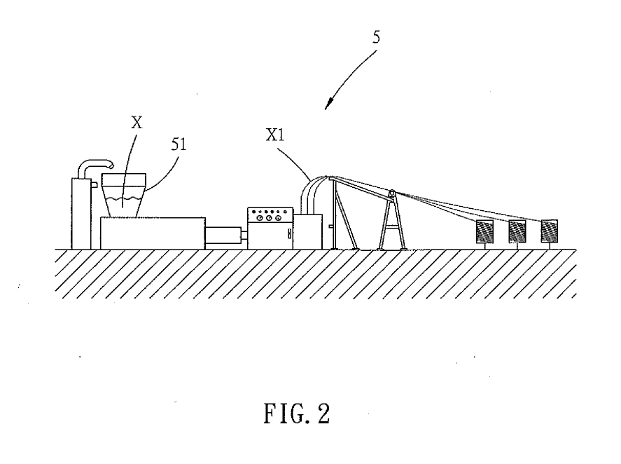

Referring to FIGS. 1 and 2 with reference to FIGS. 3-5, a method for molding a composite thread cable 21 in accordance with the preferred embodiment of the present invention comprises a first step (a), a second step (b), a third step (c), a fourth step (d) and a fifth step (e).

The first step (a) includes providing a determined amount of copper alloy staple in a melting furnace, adding a determined amount of metallic element in the melting furnace, and melting and kneading the copper alloy staple and the metallic element at a high temperature to form a copper alloy melting liquid “X”. The copper alloy staple contains an electrolytic copper with a high purity. The metallic element has a high tensile strength, is erosion resistant and is wear resistant.

The second step (b) includes filling the copper alloy melting liquid “X” into a casting furnace 51 to directly form a copper alloy embryo material “X1” by a casting process 5.

The third step (c) includes stretching the copper alloy embryo material “X1” by a tensile process to form a copper alloy wire 23 with a determined diameter.

The fourth step (d) includes blending and interweaving at least one or more than one copper alloy wire 23 with multiple multi-filament polyester fiber yarn wires 22 by a determined proportion. Each of the multi-filament polyester fiber yarn wires 22 is made of flexible material. The at least one or more than one copper alloy wire 23 is made of hard material. The multi-filament polyester fiber yarn wires 22 have a number more than that of the at least one or more than one copper alloy wire 23.

The fifth step (e) includes intertwining the at least one or more than one copper alloy wire 23 in the multi-filament polyester fiber yarn wires 22 tightly and closely to construct a composite thread cable 21 which contains the at least one or more than one copper alloy wire 23 and the multi-filament polyester fiber yarn wires 22.

The composite thread cable 21 is customized to make an aquaculture cage 20.

In practice, the at least one or more than one copper alloy wire 23 of the composite thread cable 21 has a natural antibacterial function. Thus, when the at least one or more than one copper alloy wire 23 touches the air, the at least one or more than one copper alloy wire 23 is oxidized to release the copper ions. At the same time, the multi-filament polyester fiber yarn wires 22 absorb the copper ions to achieve an antibacterial effect. Thus, the composite thread cable 21 has an antibacterial effect by provision of the at least one or more than one copper alloy wire 23, to improve the antibody, to inhibit the parasites and pathogens, and to reduce the amount of chemicals and antibiotics. In addition, the composite thread cable 21 prevents breeding and adhesion of marine organisms by action of the at least one or more than one copper alloy wire 23, so as to prevent the growth of the marine organisms. Further, by action of the at least one or more than one copper alloy wire 23, the composite thread cable 21 has an enhanced dissolved oxygen (DO), so as to improve the water circulation, and to keep a high oxygen content. Further, by action of the at least one or more than one copper alloy wire 23, the composite thread cable 21 has a high tensile strength, is erosion resistant to the sea water and is wear resistant. Further, the at least one or more than one copper alloy wire 23 is encompassed by the multi-filament polyester fiber yarn wires 22, to decrease the surface friction. Further, the composite thread cable 21 is flexible, is not broken easily and has a light weight by provision of the multi-filament polyester fiber yarn wires 22. Further, the composite thread cable 21 has a determined hardness by provision of the at least one or more than one copper alloy wire 23 and has a determined flexibility by provision of the multi-filament polyester fiber yarn wires 22, so that the composite thread cable 21 has great support strength and durability. Further, the composite thread cable 21 is assembled to construct the aquaculture cage 20 easily and conveniently, thereby simplifying the operation procedures, and decreasing the cost of assembly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A composite thread cable for an aquaculture cage, comprising:
multiple multi-filament polyester fiber yarn wires; and
at least one or more than one copper alloy wire blending and interweaving with the multi-filament polyester fiber yarn wires;
wherein:
each of the multi-filament polyester fiber yarn wires is made of flexible material;
the at least one or more than one copper alloy wire is made of hard material; and
the at least one or more than one copper alloy wire is intertwined in the multi-filament polyester fiber yarn wires tightly and closely to construct the composite thread cable.

2. The composite thread cable of claim 1, wherein a method comprises:
a first step (a) including providing a determined amount of copper alloy staple in a melting furnace, adding a determined amount of metallic element in the melting furnace, and melting and kneading the copper alloy staple and the metallic element at a high temperature to form a copper alloy melting liquid, wherein the copper alloy staple contains an electrolytic copper with a high purity, and the metallic element has a high tensile strength, is erosion resistant and is wear resistant;
a second step (b) including filling the copper alloy melting liquid into a casting furnace to directly form a copper alloy embryo material by a casting process;
a third step (c) including stretching the copper alloy embryo material by a tensile process to form a copper alloy wire with a determined diameter;
a fourth step (d) including blending and interweaving at least one or more than one copper alloy wire with multiple multi-filament polyester fiber yarn wires by a determined proportion; and
a fifth step (e) including intertwining the at least one or more than one copper alloy wire in the multi-filament polyester fiber yarn wires tightly and closely to construct a composite thread cable which contains the at least one or more than one copper alloy wire and the multi-filament polyester fiber yarn wires.

3. The composite thread cable of claim 1, wherein the multi-filament polyester fiber yarn wires have a number more than that of the at least one or more than one copper alloy wire.

4. The composite thread cable of claim 1, wherein each of the multi-filament polyester fiber yarn wires is made of Mono nylon, Multi-Mono nylon, Polyethylene, Nylon, Knotless, tetoron or Dyneema.

5. The composite thread cable of claim 1, wherein each of the multi-filament polyester fiber yarn wires is made of plastic material.
